(19) United States
(12) Patent Application Publication
(10) Pub. No.: US 2024/0158877 A1
(43) Pub. Date: May 16, 2024

(54) PRODUCTS COMPRISING CHAR AND CARBON, AND ASSOCIATED SYSTEMS, DEVICES, AND METHODS

(71) Applicant: SUNCOKE TECHNOLOGY AND DEVELOPMENT LLC, Lisle, IL (US)

(72) Inventors: John Francis Quanci, Haddonfield, NJ (US); Jonathan Hale Perkins, Lisle, IL (US); John Michael Richardson, Devon, PA (US)

(21) Appl. No.: 18/511,148

(22) Filed: Nov. 16, 2023

Related U.S. Application Data
(60) Provisional application No. 63/384,017, filed on Nov. 16, 2022.

(51) Int. Cl. C21C 7/00; C10B 5/02; C10B 53/02; C10B 57/06; C10B 57/16

(52) U.S. Cl. CPC C21C 7/0025; C10B 5/02; C10B 53/02; C10B 57/06; C10B 57/16

(57) ABSTRACT

Mixture products containing charred products and coal or coke, and associated systems, devices and methods are disclosed herein. The charred product components of the mixture products can be made by receiving an input material in an oven, and heating the oven containing the input material to a predetermined temperature of at least 900° F. for a predetermined time of no more than 48 hours to produce a charred product. Advantageously, embodiments of the present technology can enable a more efficient mixture product production process. The resulting mixture products can also have higher quality in terms of desired Coke Strength After Reaction (CSR), Coke Reactivity Index (CRI), volatile matter content, ash content, sulfur content, grain size, etc.

### CROSS-REFERENCE TO RELATED APPLICATIONS

This application claims priority to U.S. Provisional Patent Application No. 63/384,017, filed Nov. 16, 2022, and titled “CHARRED PRODUCTS AND ASSOCIATED SYSTEMS, DEVICES AND METHODS,” the disclosure of which is incorporated herein by reference in its entirety. This application is also related to U.S. patent application Ser. No. 18/501,795, filed Nov. 3, 2023, and titled “COAL BLENDS, FOUNDRY COKE PRODUCTS, AND ASSOCIATED SYSTEMS, DEVICES, AND METHODS,” and U.S. patent application Ser. No. 18/052,760, filed Nov. 4, 2022, and titled “FOUNDRY COKE PRODUCTS, AND ASSOCIATED SYSTEMS, DEVICES, AND METHODS,” the disclosures of which are incorporated herein by reference in their entireties.

### TECHNICAL FIELD

This present disclosure relates to products comprising char and carbon, and associated systems, devices, and methods.

### BACKGROUND

Existing technologies for charred product production include open-air combustion, traditional kiln methods, and modern pyrolysis reactors. Open-air combustion, while simple, often results in incomplete combustion and the release of harmful pollutants. Traditional kiln methods are labor-intensive and energy-inefficient. Other thermochemical processes such as torrefaction have been developed to address some of these issues but require substantial energy inputs, and their designs can be complex and costly. Moreover, operating temperatures for torrefaction are typically limited (e.g., to less than 900° F.), which lead to relatively long processing times. Therefore, there is a need for improved and efficient charred product production methods and systems that can offer consistent product quality, reduce energy consumption, minimize environmental impacts, and enable large-scale production for various applications.

### BRIEF DESCRIPTION OF THE DRAWINGS

Features, aspects, and advantages of the presently disclosed technology may be better understood with regard to the following drawings.

FIG. 1A is a partially schematic isometric view of a portion of a coke plant, in accordance with embodiments of the present technology.

FIG. 1B is side sectional view of the coke plant of FIG. 1A.

FIG. 2 is a schematic illustration of an oven receiving a carbonaceous input and producing a charred product output, in accordance with embodiments of the present technology.

FIG. 3 is a block flow diagram illustrating a method for producing a charred product, in accordance with embodiments of the present technology.

FIGS. 4-7 are data tables corresponding to characteristics of charred products, in accordance with embodiments of the present technology.

FIG. 8A illustrates an input material to be heated in an oven, in accordance with embodiments of the present technology.

FIGS. 8B and 8C are charred products produced via the input material of FIG. 8A.

FIGS. 9A-9D illustrate charred product being formed via an oven, in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Introduction

Embodiments of the present technology relate to products comprising char and carbon, and associated systems, devices and methods. Such products, namely coal-char mixture products and coke-char mixture products, can have properties that make such products desirable for certain industrial applications, such as steel production. For example, the charred (or double-charred) product component of the mixture can include a relatively high calcium content that can decreases the ash fusion temperature of the coke product component of the mixture, and advantageously enables more carbon transfer from the coke to molten iron within a cupola.

However, conventional methods of making charred products are limited in various aspects. For example, charcoal products are conventionally produced using kilns that are heat integrated and that heat input materials to around (or no more than) 900° F. Some production techniques include a drying stage in which a moisture content of the raw input material is reduced, a distillation stage in which hot stove gas is injected through the dried input material, a carbonization stage in which the input material undergoes torrefaction and is converted to charcoal, and a cooling stage in which the charcoal is cooled using a cold inert gas. These and related production processes have limitations, including maximum temperatures of around 900° F. and/or cycle times greater than 48 hours. As a result, the size (e.g., diameter or smallest cross-sectional dimension) of the input material and/or the moisture content of the input material is often limited (e.g., to be below 3″).

Embodiments of the present technology address at least some of the above-described issues for producing charred product. For example, embodiments of the present disclosure include receiving an input material in an oven, and heating the oven containing the input material to a predetermined temperature of at least 900° F. for a predetermined time of no more than 48 hours to produce a charred product. The predetermined temperature can be at least 950° F., 1000° F., 1050° F., 1100° F., 1150° F., 1200° F., 1250° F., 1300° F., 1400° F., 1500° F., 1750° F., 2000° F., 2250° F., 2500° F., 2800° F., or within a range of 950-2800° F., and the predetermined time can be no more than 46 hours, 44 hours, 42 hours, 40 hours, 38 hours, 36 hours, 34 hours, 32 hours, 30 hours, 28 hours, 26 hours, 24 hours, 22 hours, 20 hours, 18 hours, 16 hours, 14 hours, or within a range of 14-46 hours. The input material can include a carbonaceous feedstock, a non-metal feedstock, or a metal-containing feedstock, such as wood products (e.g., whole or split logs of hickory, oak, red oak, spruce, etc.) and/or iron fines. In some embodiments, the input materials can include one or more additives that are processed in the oven, such as calcium (e.g., calcium oxide or lime, calcium sulfate, etc.), sodium (e.g., sodium hydroxide), and/or clay. The oven can be a devolatilization oven configured to heat coal to produce coke (e.g., foundry coke, blast coke, coke breeze, etc.), and can include a heat recovery oven (as described elsewhere herein) or a non-heat recovery oven (e.g., a byproduct oven). As such, the oven can be designed to withstand temperatures up to 2800° F.

The charred product can include charcoal and/or biochar, and/or have a desired volatile matter, ash, sulfur, calcium oxide, size, and product:fines ratio. For example, the charred product can have a (i) desired volatile matter content of at least 0.1%, 0.3%, 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, or within a range of 0.1-25%, (ii) ash content of 0.1-9%, 3-8%, 4-6%, 5-6%, or no more than 8%, 7%, 6%, 5% ash, (iii) sulfur content of no more than 1%, 0.9%, 0.8%, 0.7%, 0.5%, 0.25%, 0.1%, 0.05%, or within a range of 0.05-1%, (iv) ash having at least 60%, 65%, 70%, 75%, 78%, or within a range of 60-78% calcium oxide (v) a size wherein at least 12%, 14%, 16%, 18%, 20%, or within a range of 12-20% of the charred product has a size of at least ¾ inch, or at least 6%, 8%, 10%, or within a range of 6-10% of the charred product comprises fines having a size of less than ¾″, or a size where at least 80%, 85%, 90%, 95%, 99%, or within a range of 80-99% of the charred product has a size no more than ⅛ inch, and/or (vi) a charred product:fines ratio of at least 2.0, 2.5, 3.0, 3.5, 4.0, 4.5, 5.0, 5.5, 6.0, 6.5, 7.0, 8.0, 9.0, 10.0, or within a range of 2.0-10.0.

Advantageously, embodiments of the present technology can enable a more efficient charred product production process and/or a wider range of input materials to be processed. For example, due in part to capabilities of the oven to heat products at temperatures higher than that of conventional charcoal producing processes, embodiments of the present technology can process input materials that have diameters or smallest cross-sectional dimensions that are at least 2″ (e.g., at least 4″, 6″, 8″, 12″, 18″, 24″, within a range of 2-6″, or within a range of 4-24″). Moreover, this can be done over a cycle time less than that of the conventional charcoal producing processes. As a result, embodiments of the present technology can produce charred products in an economical manner.

Embodiments of the present technology also include coal-char mixture products and coke-char mixture products. Coal-char mixture products include a mixture of one or more coal blends and a charred product. The charred product can be made from one or more of various different input materials and can be ground to a desired size to mix with the coal blends. Coke-char mixture products include a mixture of a coked product and a double-charred product. In some embodiments, the double-charred product can exhibit certain properties that are superior or more desirable to those of charred products. In some embodiments, for example, coke-char mixture products can be made by pyrolyzing or otherwise heating coal-char mixture products such that the input material for the charred product is effectively heat treated twice.

Advantageously, embodiments of the present technology can enable a more efficient product production process. The products produced according to embodiments of the present technology can also exhibit superior characteristics compared to other mixture products. For example, mixing charred products with coal blends can result in a superior mixture product than mixing biomass or other input materials that have not been processed with coal blends. The disclosed mixture products can also have higher quality in terms of desired Coke Strength After Reaction (CSR), Coke Reactivity Index (CRI), volatile matter content, ash content, sulfur content, size, etc., as disclosed herein.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the disclosed technologies can be practiced without several of the details described below.

### II. Charred Products, Mixtures Containing Charred Products, and Associated Systems, Devices, and Methods

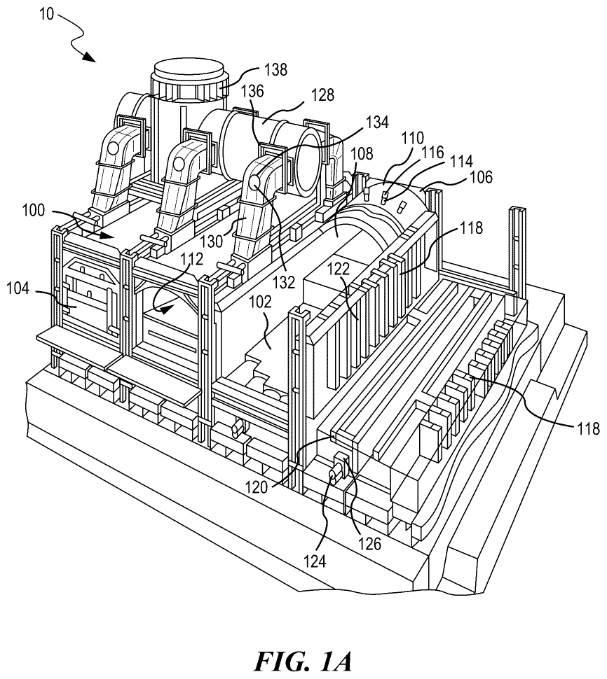

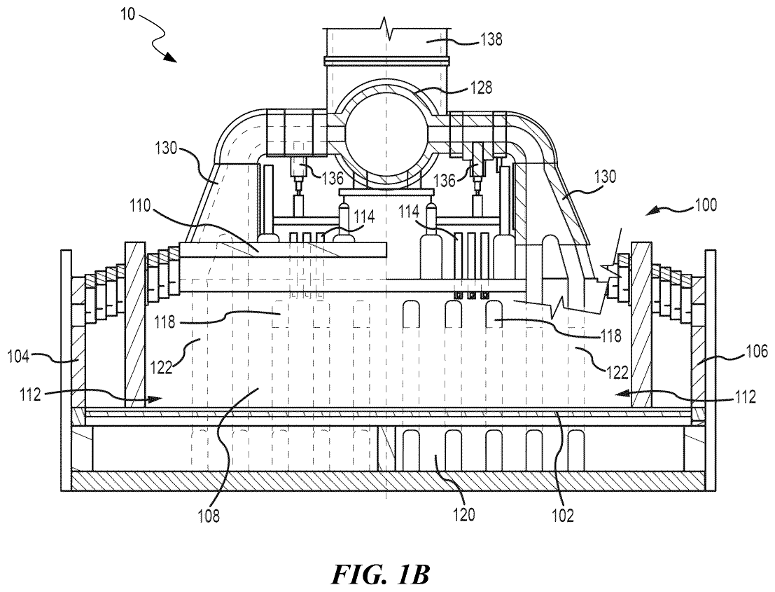

FIG. 1A is a partially schematic isometric view of a portion of a coke plant or system 10 (“system 10”), in accordance with embodiments of the present technology, and FIG. 1B is side sectional view of the coke plant of FIG. 1A. Referring to FIGS. 1A and 1B together, the system 10 includes an oven 100. The oven 100 shown is a horizontal heat recovery oven, but other ovens (e.g., non-heat recovery, by product, etc.) can also be used. As shown in FIG. 1A, the oven 100 includes an open cavity defined by an oven floor 102, a pusher side oven door 104, an output side oven door 106 opposite the pusher side oven door 104, opposite sidewalls 108 that extend upwardly from the floor 102 and between the pusher side oven door 104 and output side oven door 106, and a crown 110, which forms a top surface of the open cavity of an oven chamber 112. Controlling air flow and pressure inside the oven chamber 112 can play a significant role in the efficient operation of the heat processing cycle. Embodiments of the present technology include one or more crown air inlets 114 that allow primary combustion air into the oven chamber 112. In some embodiments, multiple crown air inlets 114 penetrate the crown 110 in a manner that selectively places oven chamber 112 in open fluid communication with the ambient environment outside the oven 100. The oven 100 may include an uptake elbow air inlet having an air damper 116, which can be positioned at any of a number of positions between fully open and fully closed to vary an amount of air flow through the air inlet. Other oven air inlets, including door air inlets and the crown air inlets 114 include air dampers 116 that operate in a similar manner. The uptake elbow air inlet may be positioned to allow air into the common tunnel 128, whereas the door air inlets and the crown air inlets 114 vary an amount of air flow into the oven chamber 112. While embodiments of the present technology may use crown air inlets 114, exclusively, to provide primary combustion air into the oven chamber 112, other types of air inlets, such as the door air inlets, may be used in particular embodiments without departing from aspects of the present technology.

Various air inlets can be used with or without one or more air distributors to direct, circulate, and/or distribute air within the oven chamber. The term “air”, as used herein, can include ambient air, oxygen, oxidizers, nitrogen, nitrous oxide, diluents, combustion gases, air mixtures, oxidizer mixtures, flue gas, recycled vent gas, steam, gases having additives, inerts, heat-absorbers, liquid phase materials such as water droplets, multiphase materials such as liquid droplets atomized via a gaseous carrier, aspirated liquid fuels, atomized liquid heptane in a gaseous carrier stream, fuels such as natural gas or hydrogen, cooled gases, other gases, liquids, or solids, or a combination of these materials. In various embodiments, the air inlets and/or distributors can function (i.e., open, close, modify an air distribution pattern, etc.) in response to manual control or automatic advanced control systems. The air inlets and/or air distributors can operate on a dedicated advanced control system or can be controlled by a broader draft control system that adjusts the air inlets and/or distributors as well as uptake dampers, sole flue dampers, and/or other air distribution pathways within coke oven systems.

In operation, volatile gases emitted from input materials positioned inside the oven chamber 112 can collect in the crown and be drawn downstream into downcomer channels 118 formed in one or both sidewalls 108. The downcomer channels 118 can fluidly connect the oven chamber 112 with a sole flue 120, which is positioned beneath the oven floor 102. The sole flue 120 can form a circuitous path beneath the oven floor 102. Volatile gases emitted from the input materials can be combusted in the sole flue 120, thereby, generating heat to support the processing of the input materials to produce processed materials (e.g., reduction of coal into coke). The downcomer channels 118 are fluidly connected to uptake channels 122 formed in one or both sidewalls 108. A secondary air inlet 124 can be provided between the sole flue 120 and atmosphere, and the secondary air inlet 124 can include a secondary air damper 126 that can be positioned at any of a number of positions between fully open and fully closed to vary the amount of secondary air flow into the sole flue 120. The uptake channels 122 are fluidly connected to a common tunnel 128 by one or more uptake ducts 130. A tertiary air inlet 132 can be provided between the uptake duct 130 and atmosphere. The tertiary air inlet 132 can include a tertiary air damper 134, which can be positioned at any of a number of positions between fully open and fully closed to vary the amount of tertiary air flow into the uptake duct 130.

Each uptake duct 130 includes an uptake damper 136 that may be used to control gas flow through the uptake ducts 130 and within the ovens 100. The uptake damper 136 can be positioned at any number of positions between fully open and fully closed to vary the amount of oven draft in the oven 100. The uptake damper 136 can comprise any automatic or manually-controlled flow control or orifice blocking device (e.g., any plate, seal, block, etc.). For example, the uptake damper 136 is set at a flow position between 0 and 2, which represents “closed,” and 14, which represents “fully open.” It is contemplated that even in the “closed” position, the uptake damper 136 may still allow the passage of a small amount of air to pass through the uptake duct 130. Similarly, it is contemplated that a small portion of the uptake damper 136 may be positioned at least partially within a flow of air through the uptake duct 130 when the uptake damper 136 is in the “fully open” position. It will be appreciated that the uptake damper may take a nearly infinite number of positions between 0 and 14. Some exemplary settings for the uptake damper 136, increasing in the amount of flow restriction, include: 12, 10, 8, and 6. In some embodiments, the flow position number simply reflects the use of a fourteen inch uptake duct, and each number represents the amount of the uptake duct 130 that is open, in inches. Otherwise, it will be understood that the flow position number scale of 0-14 can be understood simply as incremental settings between open and closed.

As used herein, “draft” indicates a negative pressure relative to atmosphere. For example, a draft of 0.1 inches of water indicates a pressure of 0.1 inches of water below atmospheric pressure. Inches of water is a non-SI unit for pressure and is conventionally used to describe the draft at various locations in a coke plant. In some embodiments, the draft ranges from about 0.12 to about 0.16 inches of water. If a draft is increased or otherwise made larger, the pressure moves further below atmospheric pressure. If a draft is decreased, drops, or is otherwise made smaller or lower, the pressure moves towards atmospheric pressure. By controlling the oven draft with the uptake damper 136, the air flow into the oven 100 from the crown air inlets 114, as well as air leaks into the oven 100, can be controlled. Typically, as shown in FIG. 1B, an individual oven 100 includes two uptake ducts 130 and two uptake dampers 136, but the use of two uptake ducts and two uptake dampers is not a necessity; a system can be designed to use just one or more than two uptake ducts and two uptake dampers.

In operation, processed materials (e.g., charred products, coke, etc.) are produced in the ovens 100 by first charging an input material (e.g., wood, biomass, iron fines, additives, etc.) into the oven chamber 112, heating the input material in an oxygen limited (e.g., oxygen depleted) environment, driving off the volatile fraction of the input material, and then oxidizing the volatile matter (VM) within the oven 100 to capture and use the heat given off. In some embodiments, the oven 100 is configured to apply partial densification to the input materials. In some embodiments, in operation, mixtures of processed materials (e.g., mixtures of double-charred products and coke) are produced in the ovens 100 by first charging input mixtures (e.g., mixtures of charred products and coal blends), heating the input material in an oxygen limited (e.g., oxygen depleted) environment, driving off the volatile fraction of the input mixtures, and then oxidizing the volatile matter (VM) within the oven 100 to capture and use the heat given off.

In some embodiments, the input material can include a carbonaceous feedstock, a non-metal feedstock, or a metal-containing feedstock. In some embodiments, the carbonaceous feedstock may include at least one of wood, biomass, petroleum residue, or a waste feedstock. Additionally or alternatively, the carbonaceous feedstock can include a bundle of wood logs that is approximately 10 feet long, 4 feet tall and 4 feet wide. Individual wood logs can have a diameter or smallest cross-sectional dimension of at least 4″, 6″, 8″, 10″ 12″, 14″, 16″, 18″, 20″, 22″, 24″, or within a range of 2-24″. In some embodiments, the metal-containing feedstock may include a raw mineral material or a recycled metal-containing material.

When the input material comprises a carbonaceous feedstock, VMs of the carbanaceous feedstock is oxidized within the oven 100 over a coking cycle and releases heat to regeneratively drive the carbonization of the feedstock to produce coke or a charred product. The coking cycle begins when the pusher side oven door 104 is opened and the input material is charged onto the oven floor 102 in a manner that defines an input material bed. Heat from the oven (e.g., due to the previous coking cycle) starts the carbonization cycle. In many embodiments, no additional fuel other than that produced by the coking process is used. Roughly half of the total heat transfer to the input material bed is radiated down onto the top surface of the coal bed from the luminous flame of the input material bed and the radiant oven crown 110. The remaining half of the heat is transferred to the coal bed by conduction from the oven floor 102 which is convectively heated from the volatilization of gases in the sole flue 120. In this way, a carbonization process “wave” of plastic flow of the coal particles and formation of high strength cohesive coke proceeds from both the top and bottom boundaries of the coal bed.

In some embodiments, each oven 100 is operated at negative pressure so air is drawn into the oven during the reduction process due to the pressure differential between the oven 100 and atmosphere. Primary air for combustion is added to the oven chamber 112 to at least partially oxidize the volatiles from the input material. In some embodiments, the amount of this primary air is controlled so that only a portion of the volatiles released from the coal are combusted in the oven chamber 112, thereby, releasing only a fraction of their enthalpy of combustion within the oven chamber 112. In various embodiments, the primary air is introduced into the oven chamber 112 above the coal bed through the crown air inlets 114, with the amount of primary air controlled by the crown air dampers 116. In other embodiments, different types of air inlets may be used without departing from aspects of the present technology. For example, primary air may be introduced to the oven through air inlets, damper ports, and/or apertures in the oven sidewalls or doors. Regardless of the type of air inlet used, the air inlets can be used to maintain the desired operating temperature inside the oven chamber 112. Increasing or decreasing primary air flow into the oven chamber 112 through the use of air inlet dampers may increase or decrease VM combustion in the oven chamber 112 and, hence, temperature.

The oven 100 may be provided with crown air inlets 114 configured, in accordance with embodiments of the present technology, to introduce combustion air through the crown 110 and into the oven chamber 112. In one embodiment, three crown air inlets 114 are positioned between the pusher side oven door 104 and a mid-point of the oven 100, along an oven length. Similarly, three crown air inlets 114 are positioned between the coke side oven door 106 and the mid-point of the oven 100. It is contemplated, however, that one or more crown air inlets 114 may be disposed through the oven crown 110 at various locations along the oven's length. The chosen number and positioning of the crown air inlets depends, at least in part, on the configuration and use of the oven 100. Each crown air inlet 114 can include an air damper 116, which can be positioned at any of a number of positions between fully open and fully closed, to vary the amount of air flow into the oven chamber 112. In some embodiments, the air damper 116 may, in the “fully closed” position, still allow the passage of a small amount of ambient air to pass through the crown air inlet 114 into the oven chamber. Accordingly, various embodiments of the crown air inlets 114, uptake elbow air inlet, or door air inlet, may include a cap that may be removably secured to an open upper end portion of the particular air inlet. The cap may substantially prevent weather (such as rain and snow), additional ambient air, and other foreign matter from passing through the air inlet. It is contemplated that the oven 100 may further include one or more distributors configured to channel/distribute air flow into the oven chamber 112.

In various embodiments, the crown air inlets 114 are operated to introduce ambient air into the oven chamber 112 over the course of the heat processing cycle much in the way that other air inlets, such as those typically located within the oven doors, are operated. However, use of the crown air inlets 114 provides a more uniform distribution of air throughout the oven crown, which has shown to provide better combustion, higher temperatures in the sole flue 120 and later cross over times when the reactions in the oven 100 change from an exothermic process to an endothermic process. The uniform distribution of the air in the crown 110 of the oven 110 reduces the likelihood that the air will contact the surface of the feedstock bed and create hot spots that create burn losses on the feedstock surface. Rather, the crown air inlets 114 substantially reduce the occurrence of such hot spots, creating a uniform feedstock bed surface as the heat processing proceeds. In particular embodiments of use, the air dampers 116 of each of the crown air inlets 114 are set at similar positions with respect to one another. Accordingly, where one air damper 116 is fully open, all of the air dampers 116 can be placed in the fully open position; if one air damper 116 is set at a half open position, all of the air dampers 116 can be set at half open positions. However, in particular embodiments, the air dampers 116 can be changed independently from one another. In various embodiments, the air dampers 116 of the crown air inlets 114 can be opened up quickly after the oven 100 is charged or right before the oven 100 is charged. A first adjustment of the air dampers 116 to a ¾ open position is made at a time when a first door hole burning would typically occur. A second adjustment of the air dampers 116 to a ½ open position is made at a time when a second door hole burning would occur. Additional adjustments are made based on operating conditions detected throughout the coke oven 100.

The partially combusted gases pass from the oven chamber 112 through the downcomer channels 118 into the sole flue 120 where secondary air is added to the partially combusted gases. The secondary air is introduced through the secondary air inlet 124. The amount of secondary air that is introduced is controlled by the secondary air damper 126. As the secondary air is introduced, the partially combusted gases are more fully combusted in the sole flue 120, thereby, extracting the remaining enthalpy of combustion which is conveyed through the oven floor 102 to add heat to the oven chamber 112. The fully or nearly-fully combusted exhaust gases exit the sole flue 120 through the uptake channels 122 and then flow into the uptake duct 130. Tertiary air is added to the exhaust gases via the tertiary air inlet 132, where the amount of tertiary air introduced is controlled by the tertiary air damper 134 so that any remaining fraction of non-combusted gases in the exhaust gases are oxidized downstream of the tertiary air inlet 132. At the end of the heat processing cycle, the input material has processed to produce processed materials. The processed materials may be removed from the oven 100 through the output side oven door 106 utilizing a mechanical extraction system, such as a pusher ram. Finally, the processed materials may be quenched (e.g., wet or dry quenched). In some embodiments, the oven 100 may be configured to allow the processed materials to cool before the processed materials are removed from the oven 100. At least a portion of the heat from the cooling of the processed materials inside the oven 100 or outside the oven 100 may be recycled and utilized. For instance, the heat from the cooling of the processed materials inside the oven 100 may be used to maintain the temperature inside the oven 100, or dry fresh input material. As another example, the heat from the cooling of the processed materials inside the oven 100 may be used to preheat fresh input material before it is fed to the oven 100, or heat water to generate steam suitable for use in the system 10 or somewhere else.

In some embodiments, the processing period may be set before the heat processing starts. In some embodiments, the processing period may be adjusted substantially real time as the heat processing proceeds. In some embodiments, the processing period may be determined or controlled based on an operation parameter relating to the heat processing in the oven 100. Exemplary operation parameters include at least one of a temperature at an opening of or at a location inside the oven 100, a composition of an exhaust (or referred to as exhaust gas) of the oven 100, a gas flow rate of the exhaust, or a temperature at an external surface of the oven 100.

In some embodiments, the system 10 can include multiple ovens 100, and in such embodiments, at least two of the multiple ovens 100 are thermally coupled such that one constitutes a source of heat to the other. For example, a second oven 100 can be configured to heat materials that undergo an exothermic process, and at least a portion of the heat generated in the exothermic process in the second oven 100 is transferred to a first oven 100, which undergoes an endothermic reaction. As another example, the system 10 can include three ovens 100 arranged side by side so that two side ovens 100 are located on the opposite sides of the middle oven 100; at least one of the two side ovens 100 may be thermally coupled with the middle oven 100 such that the at least one side oven 100 may constitute a source of heat to the middle oven 100. In such embodiments, the middle oven may be configured to produce charred product, which is an endothermic process, and the adjacent ovens may be configured to produce coke product, which is an exothermic process, and provide heat to the middle oven.

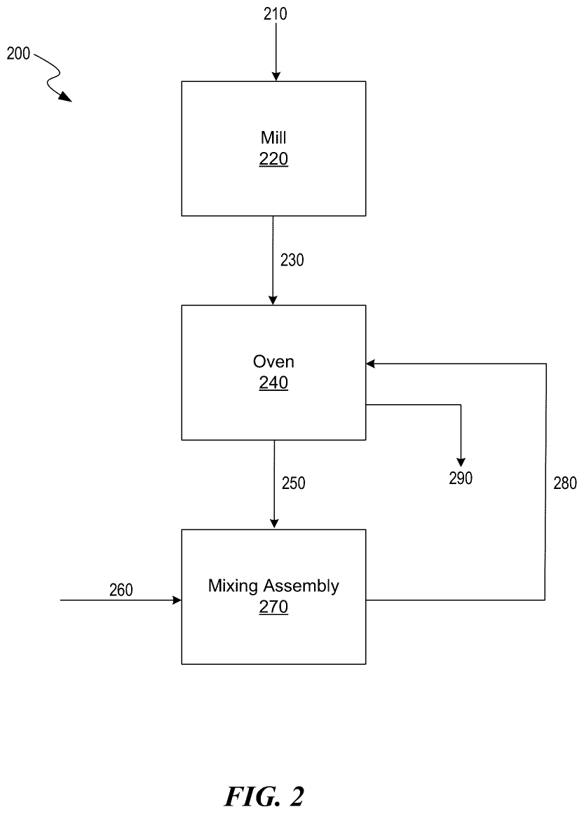

FIG. 2 is a schematic illustration of a system 200 including a grinder or mill 220 (“mill 220”), an oven 240, and a mixing assembly 270. The mill 220 can be configured to receive and grind input material 210 to reduce the size of the input material 210. The oven 240 can be configured to receive the ground input material 230 and produce a charred product 250, in accordance with embodiments of the present technology. The mixing assembly 270 can be configured to receive and mix the charred product 250 from the oven 240 and one or more coal blends 260 (e.g., coal blends for making foundry coke or blast coke) to produce a coal-char mixture product 280. The oven 240 (or a different oven) can be configured to receive the coal-char mixture product 280 and produce a coke-char mixture product 290. Therefore, the coke-char mixture product 290 can include a coked product (e.g., foundry coke) and a double-charred product. In some embodiments, the materials can go through the mill 220, the oven 240, and/or the mixing assembly 270 fewer times, more times, or in a different order.

The system 200 can be similar to the system 100 described with reference to FIGS. 1A and 1B, and include any one or more of the features described therein. For example, the input material 210 can correspond to the input material(s) described with reference to FIGS. 1A and 1B, the oven 240 can correspond to the oven(s) 100 described with reference to FIGS. 1A and 1B, and the charred product 250 can correspond to the charred product(s) described with reference to FIGS. 1A and 1B.

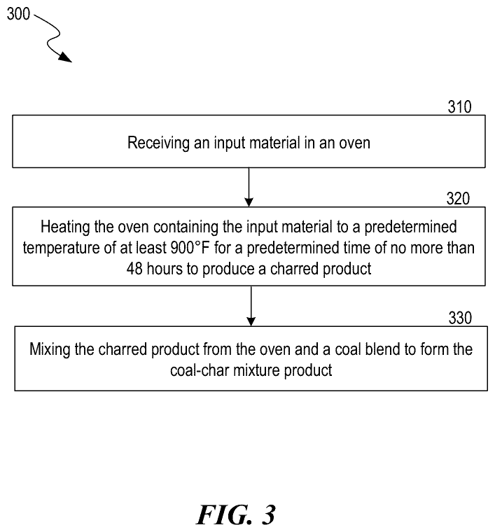

FIG. 3 is a block flow diagram illustrating a method 300 for producing a coal-char mixture product, in accordance with embodiments of the present technology. The method 300 includes receiving an input material in an oven (process portion 310), The oven can include the ovens described herein with respect to FIGS. 1A-2, and/or any oven configured to process coal to produce coke products, including a heat recovery or non-heat recovery oven. The input material can include any of the input materials described with reference to FIGS. 1A-2. For example, the input material can include a carbonaceous feedstock, a non-metal feedstock, or a metal-containing feedstock. The carbonaceous feedstock can include wood, biomass, petroleum residue, or a waste feedstock. The wood can include hickory, oak, red oak, or spruce. Additionally or alternatively, the carbonaceous feedstock can include whole logs, split wood, stumps, and/or a bundle of wood logs as described above. Individual wood logs can have a diameter or smallest cross-sectional dimension of at least 4″, 6″, 8″, 10″ 12″, 14″, 16″, 18″, 20″, 22″, 24″, or within a range of 2-24″. Additionally or alternatively, the input material can have an input moisture content of at least 10%, 12%, 14%, 16%, 18%, 20%, 22%, 24%, 26%, 28%, 30%, 40%, 50%, or within a range of 10-50%. In some embodiments, the input material includes, e.g., in addition to the carbonaceous feedstock, one of more additives. The additives can include calcium (e.g., calcium oxide or lime, calcium sulfate, etc.), sodium (e.g., sodium hydroxide), and/or clay. In some embodiments, the metal-containing feedstock may include a raw mineral material or a recycled metal-containing material.

The method 300 can further comprise heating the oven containing the input material to a predetermined temperature of at least 900° F. for a predetermined time of no more than 48 hours to produce a charred product (e.g., the charred product 250) (process portion 320). The method 300 can further comprise mixing the charred product from the oven and a coal blend to form the coal-char mixture product (e.g., the coal-char mixture product 280) (process portion 320). In some embodiments, the charred product and the coal blend are mixed in a mixing assembly (e.g., the mixing assembly 270) that is operated autonomously or manually. In some embodiments, more than one coal blend is mixed with the charred product. In some embodiments, the coal-char mixture product can have a mass ratio of the charred product that is at least 1%, 2%, 3%, 4%, 5%, 10%, 15%, 20%, 25%, or 30%, or within a range of 1-30%, 1-15%, or 15-30%. In some embodiments, the coal-char mixture product can have any one or more of the characteristics (e.g., ash content, sulfur content, calcium oxide content, size, charred product:fines ratio, volatile matter content) discussed above with respect to the charred product.

The method 300 can comprise additional process portions. For example, the method 300 can further comprise grinding the input materials to a desired grain size, such as 10-mesh or at least 2 mm, 3 mm, or 4 mm, or within a range of 2-4 mm. In another example, the method 300 can further comprise cooling the charred product and/or the coal-char mixture product for at least 24 hours after production, e.g., until the product reaches a temperatures of no more than 120° F. Cooling can include fluidically isolating the charred product and/or the coal-char mixture product from oxygen (or limiting the exposure of the charred product to oxygen), e.g., by placing or encasing the charred product and/or the coal-char mixture product in an at least partially enclosed container, and cooling the at least partially enclosed container, the charred product and/or the coal-char mixture product to 120° F. or less in the oven while the charred product is fluidically isolated.

The method 300 can further comprise receiving the coal-char mixture product in the oven, and heating the oven containing the coal-char mixture product to a second predetermined temperature of at least 900° F. for a second predetermined time of no more than 48 hours to produce a coke-char mixture product (e.g., the coke-char mixture product 290), based on customer or product needs. As an example, the coke-char mixture product can include a double-charred product, which contains relatively high calcium content and low sulfur content, and foundry coke product for use in foundry cupolas. Without being bound by theory, the calcium content can decrease the ash fusion temperature of the foundry coke product, and advantageously enable more carbon transfer from the coke to the molten iron within the cupola. The method 300 can further comprise, cooling the coke-char mixture product.

The predetermined temperature (when heating the input material) and/or the second predetermined temperature (when heating the coal-char mixture product) can be at least 950° F., 1000° F., 1050° F., 1100° F., 1150° F., 1200° F., 1250° F., 1300° F., 1400° F., 1500° F., 1750° F., 2000° F., 2250° F., 2500° F., 2800° F., or within a range of 950-2800° F. The predetermined time (when heating the input material) and/or the second predetermined time (when heating the coal-char mixture product) can be no more than 46 hours, 44 hours, 42 hours, 40 hours, 38 hours, 36 hours, 34 hours, 32 hours, 30 hours, 28 hours, 26 hours, 24 hours, 22 hours, 20 hours, 18 hours, 16 hours, 14 hours, or within a range of 14-46 hours. Advantageously, such temperatures are higher than the temperatures used for conventional charred product production processes and, relatedly, such times are lower than the times used for conventional charred product production processes.

The charred product, the coal-char mixture product, and/or the coke-char mixture product can include any of the charred products or characteristics thereof described with reference to FIGS. 1A-2. For example, the charred products can include charcoal and/or biochar. The charred product, the coal-char mixture product, and/or the coke-char mixture product can have a desired ash, sulfur, calcium oxide, size, and product:fines ratio. For example, the charred product, the coal-char mixture product, and/or the coke-char mixture product can have a (i) desired volatile matter content of 0.1%, 0.3%, 0.5%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, or within a range of 0.1-25%, (ii) ash content of 0.1-9%, 3-8%, 4-6%, 5-6%, or no more than 8%, 7%, 6%, 5% ash, (iii) sulfur content of no more than 1%, 0.9%, 0.8%, 0.7%, 0.5%, 0.25%, 0.1%, 0.05%, or within a range of 0.05-1%, (iv) ash having at least 60%, 65%, 70%, 75%, 78%, or within a range of 60-78% of calcium oxide (v) a size wherein at least 12%, 14%, 16%, 18%, 20%, or within a range of 12-20% of the charred product has a size of at least ¾ inch, or at least 6%, 8%, 10%, or within a range of 6-10% of the charred product comprises fines having a size of less than ¾″, or a size where at least 80%, 85%, 90%, 95%, 99%, or within a range of 80-99% of the charred product has a size no more than ⅛ inch, and/or (vi) a charred product:fines ratio of at least 2.0, 2.5, 3.0, 3.5, 4.5, 5.0, 5.5, 6.0, 6.5, 7.0, 8.0, 9.0, 10.0, or within a range of 2.0-10.0.

In some embodiments, the charred product, the coal-char mixture product, and/or the coke-char mixture product are produced such that the volatile matter content is at least 0.1%, 0.5%, 1%, 3%, 5%, or within a range of 0.1-5%. Additionally or alternatively, the volatile matter content may vary amongst individual charred products. For example, the charred and/or mixture product can have an average volatile matter content of 4-6%, wherein a first amount of individual particles of the charred product comprises a volatile matter content of no more than 2%, and a second amount of individual particles of the charred product comprises a volatile matter content of at least 8%. In another example, the charred and/or mixture product can have an average volatile matter content of 1-5%, wherein a first amount of individual particles of the mixture product comprises a volatile matter content of no more than 1%, and wherein a second amount of individual particles of the mixture product comprises a volatile matter content of at least 5%.

In some embodiments, the charred product, the coal-char mixture product, and/or the coke-char mixture product includes grains having an average cross-sectional dimension of around 10-mesh or at least 2 mm, 3 mm, 4 mm, or within a range of 2-4 mm (e.g., achieved by the mill 220). In some embodiments, the charred product, the coal-char mixture product, and/or the coke-char mixture product includes a coked product with (i) a Coke Strength After Reaction (CSR) of no more than 2%, 1%, 0.5%, 0.1%, or within a range of 0.1-2%, and/or (ii) a Coke Reactivity Index (CRI) of at least 30%, 40%, 50%, 60%, or within a range of 30-60%.

Overall, the coked product of the mixture products disclosed herein can have low CSR values, high CRI values, low volatile matter content, low ash content, low sulfur content, and high inert content. The manufacturing process is also more efficient and produces less or minimal carbon dioxide.

### III. Experimental Results

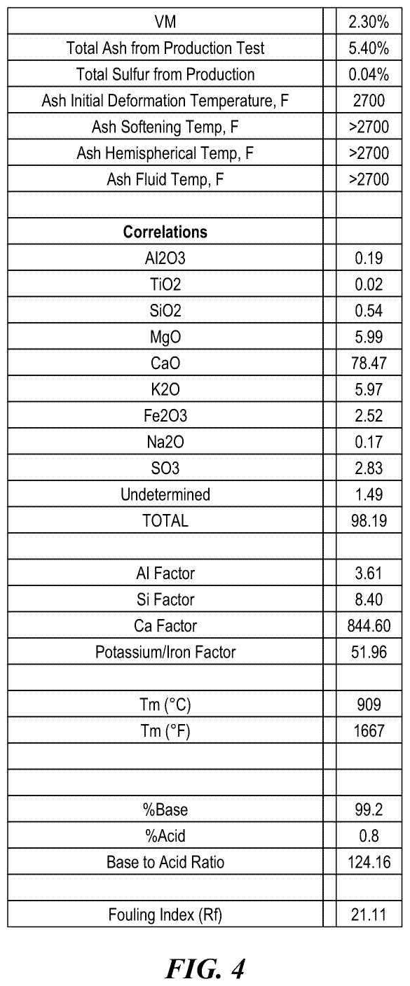

FIGS. 4-7 illustrate data tables corresponding to characteristics of charred products, in accordance with embodiments of the present technology. Referring first to FIG. 4, the table shows values for various characteristics of charred products produced via systems and methods described herein. As shown in FIG. 4, the characteristics include volatile matter (VM), total ash, total sulfur, ash initial deformation temperature, ash softening temperature ash hemispherical temperature, and ash fluid temperature. Additionally, FIG. 4 also shows a chemical composition content of the charred product, including aluminum oxide (Al₂O₃), titanium dioxide (TiO₂), silicon dioxide (SiO₂), magnesium oxide (MgO), calcium oxide (CaO), potassium oxide (K₂O), iron oxide (Fe₂O₃) sodium oxide (Na₂O), and sulfur trioxide (SO₃). FIG. 4 also show a percent base and percent acid of the charred products, and a fouling index (R_{f}).

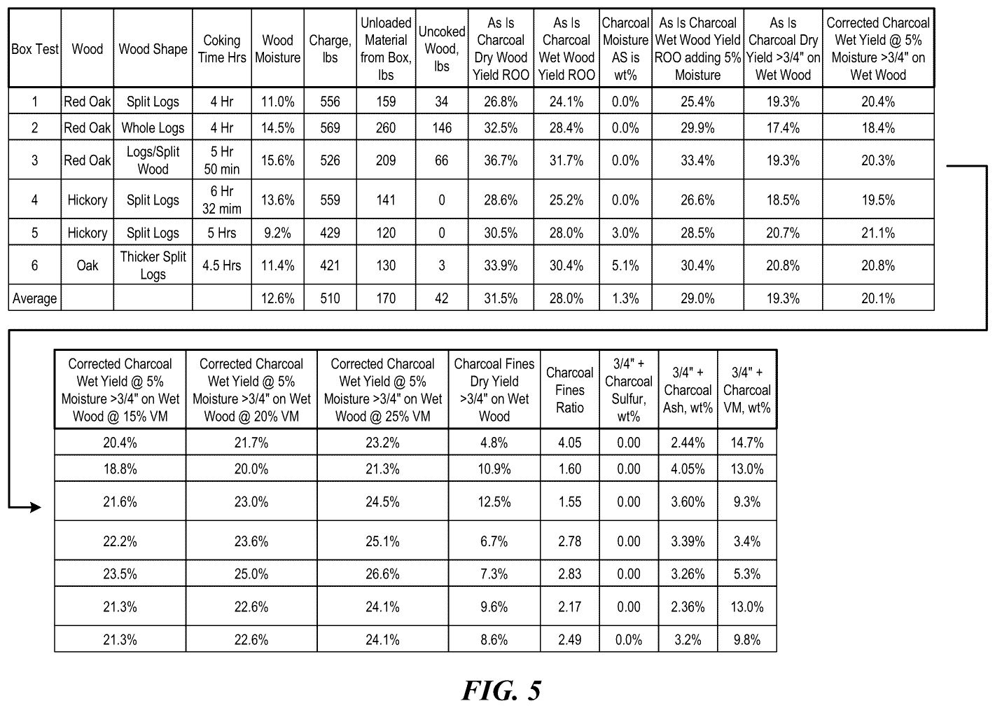

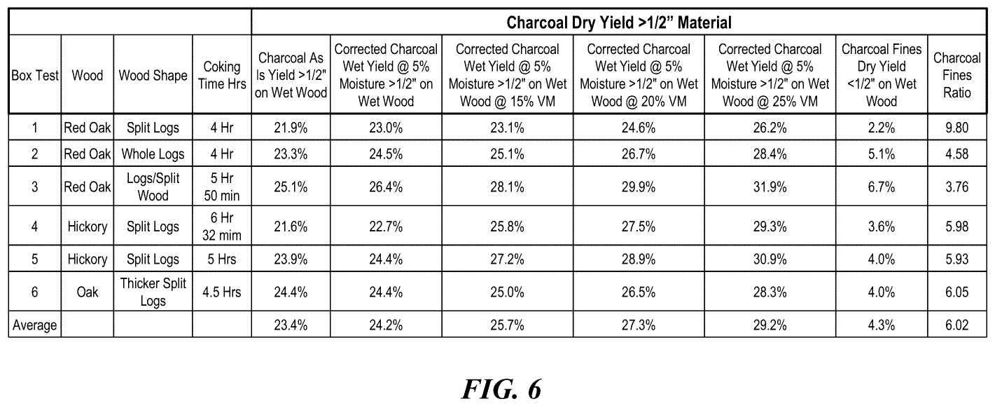

FIG. 5 illustrates a table including characteristics of the charred product or charcoal, and the input material used to produce the charcoal. For example, as shown in FIG. 5, the table includes the type of wood used (e.g., red oak, hickory, or oak), the wood shape, coking time, wood moisture, charge weight, charcoal yield on a dry wood basis, charcoal yield on a wet wood basis, charcoal moisture, charcoal wet yield, charcoal dry yield, charcoal fines dry yield, charcoal fines ratio, charcoal sulfur, charcoal ash, and charcoal VM. For each of the tests, wood was placed in a container and combusted in an oven (e.g., the oven 100; FIGS. 1A and 1B) to produce charcoal. It is noted that certain characteristics shown in the table of FIG. 5 (e.g., the coking time, charge weight, unloaded material weight and uncoked wood weight) may apply only to the tests and not to actual production. For example, a fully charged oven may have a coking time of approximately 24 hours instead of the 4-7 hours shown in the table, a higher charge weight, etc. FIG. 6 illustrates a table including characteristics of the charred product of at least ½″, and FIG. 7 illustrates a table including size distributions (e.g., ½″, ¾″, 1″, 2″, 3″+) for each box text shown in FIGS. 5 and 6.

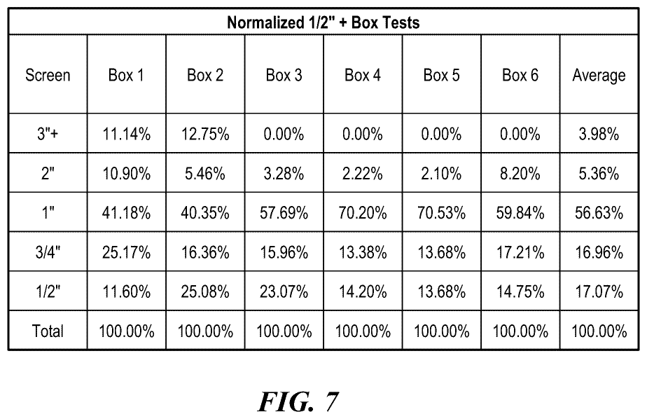

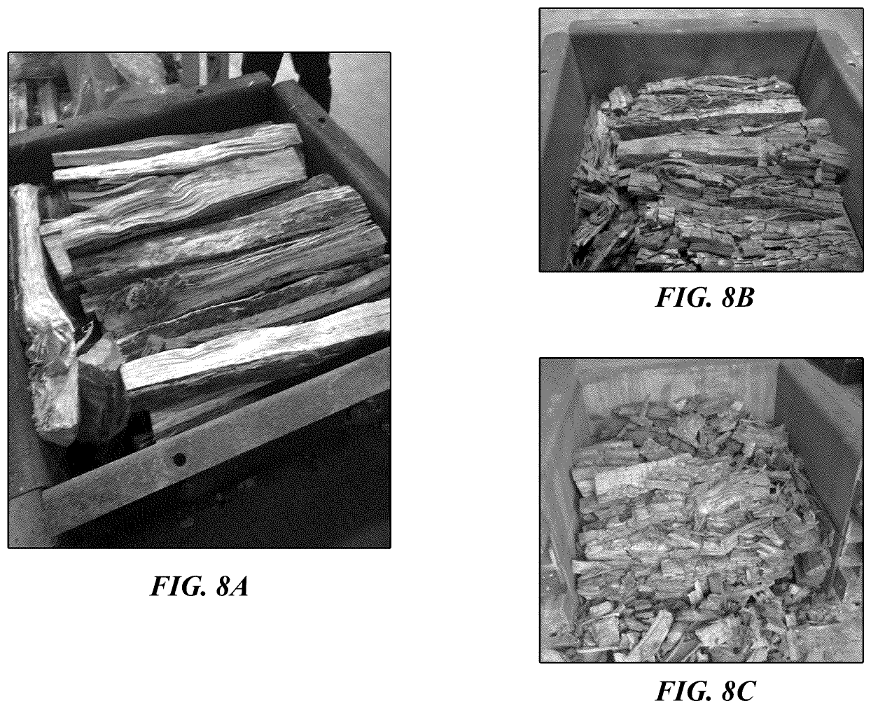

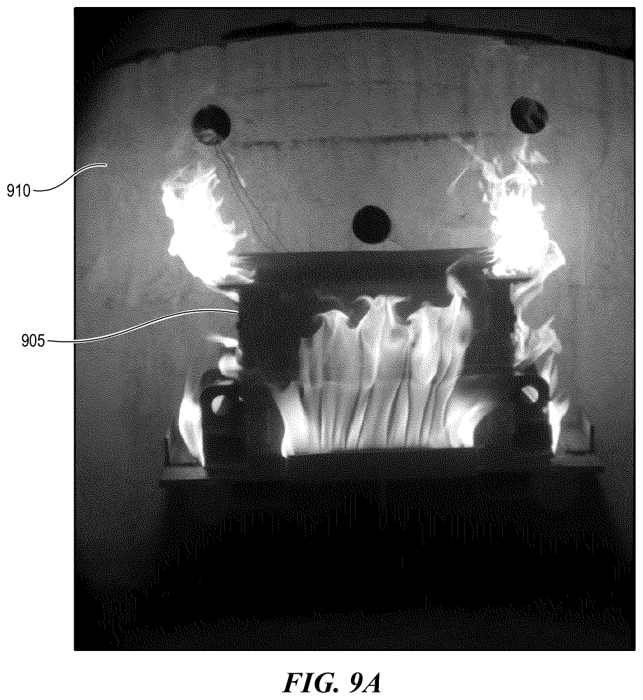

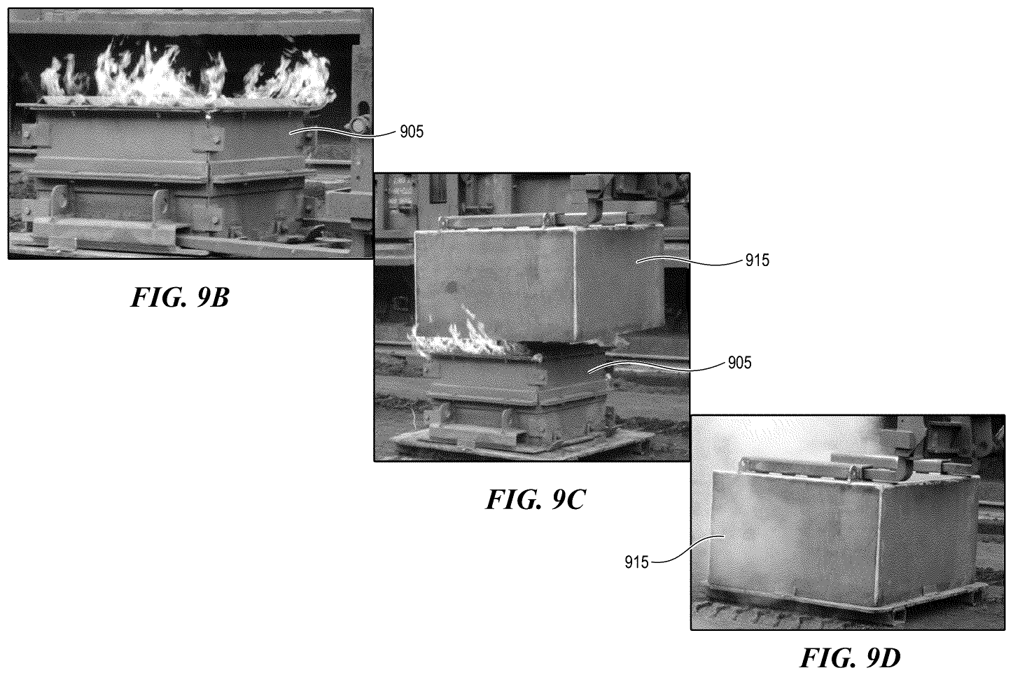

FIG. 8A illustrates split wood logs packed in a container to be heated in a combustion oven, and FIGS. 8B and 8C are charred products produced via the input material of FIG. 8A. The container is approximately 3′×3′×2 and, when processed in the oven, has a cover that limits air ingress. In operation, the split wood logs were loaded into the container which include multiple thermocouples for monitoring temperature during devolatilization in the oven. Once devolatilization is complete, which occurs when smoke is no longer leaving the container, the container is removed from the oven to be cooled. Once removed, a cover (as shown in FIGS. 9B-9D) is placed over the container to prevent air intrusion, and the container is cooled for at least 24 hours.

FIGS. 9A-9D illustrates charred product being formed via a devolatilization oven, in accordance with embodiments of the present technology. FIG. 9A is an image of a container 905 loaded with a carbonaceous input material. The container 905 is shown within a devolatilization oven and positioned against a door of the oven. The container 905 was heated within the oven until the carbonaceous input material is devolatilized and converted to charcoal. FIG. 9B is an image of the container 905 being removed from the oven after devolatilization, prior to the charcoal of the container 905 being cooled for at least 24 hours. FIG. 9C is an image of a cover 915 being placed over the container 905 to prevent air intrusion into the container 905, and FIG. 9D is an image of the cover 915 disposed over the container 905.

### IV. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Throughout this disclosure, the singular terms “a,” “an,” and “the” include plural referents unless the context clearly indicates otherwise. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing temperatures, compositions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosure set forth above is not to be interpreted as reflecting an intention that any claim requires more features than those expressly recited in that claim. Rather, as the following claims reflect, inventive aspects lie in a combination of fewer than all features of any single foregoing disclosed embodiment. Thus, the claims following this Detailed Description are hereby expressly incorporated into this Detailed Description, with each claim standing on its own as a separate embodiment. This disclosure includes all permutations of the independent claims with their dependent claims.

The present technology is illustrated, for example, according to various aspects described below as numbered clauses (1, 2, 3, etc.) for convenience. These are provided as examples and do not limit the present technology. It is noted that any of the dependent clauses may be combined in any combination, and placed into a respective independent clause. The other clauses can be presented in a similar manner.

1. A method for producing a charred product, the method comprising:
receiving an input material in an oven;
heating the oven containing the input material to a predetermined temperature of at least 900° F. for a predetermined time of no more than 48 hours to produce a charred product.

2. The method of any one of the clauses herein, wherein the input material comprises at least one of a carbonaceous feedstock, a non-metal feedstock, or a metal-containing feedstock.

3. The method of any one of the clauses herein, wherein the input material comprises a metal-containing feedstock including a raw mineral material or a recycled metal-containing material.

4. The method of any one of the clauses herein, wherein the input material comprises iron fines.

5. The method of any one of the clauses herein, wherein the input material comprises an additive including calcium (e.g., calcium oxide or lime, calcium sulfate, etc.), sodium (e.g., sodium hydroxide), and/or clay.

6. The method of any one of the clauses herein, wherein at least some of the input material have a smallest cross-sectional dimension of at least 2 inches, 3 inches, 4 inches, 5 inches, or 6 inches.

7. The method of any one of the clauses herein, wherein the input material has an input moisture content of at least 10%, 12%, 14%, 16%, 18%, 20%, 22%, 24%, 26%, 28%, 30%, 40%, 50%, or within a range of 10-50%.

8. The method of any one of the clauses herein, wherein the wood comprises logs having an average cross-sectional diameter or dimension of at least 2″, 4″, 6″, 8″, 10″ 12″, 14″, 16″, 18″, 20″, 22″, 24″, or within a range of 2-24″.

9. The method of any one of the clauses herein, wherein the predetermined time is no more than 46 hours, 44 hours, 42 hours, 40 hours, 38 hours, 36 hours, 34 hours, 32 hours, 30 hours, 28 hours, 26 hours, 24 hours, 22 hours, 20 hours, 18 hours, 16 hours, 14 hours, or within a range of 14-46 hours.

10. The method of any one of the clauses herein, wherein the predetermined temperature is at least 950° F., 1000° F., 1050° F., 1100° F., 1150° F., 1200° F., 1250° F., 1300° F., 1400° F., 1500° F., 1750° F., 2000° F., 2250° F., 2500° F., 2800° F., or within a range of 950-2800° F.

11. The method of any one of the clauses herein, wherein the predetermined temperature is within a range of 1150-1300° F., 1200-1300° F., or 1200-1250° F.

12. The method of any one of the clauses herein, wherein the charred product comprises charcoal and the input material comprises wood.

13. The method of any one of the clauses herein, wherein the charred product comprises charcoal and the input material comprises at least one of oak, red oak, hickory, or spruce.

14. The method of any one of the clauses herein, wherein the charred product comprises charcoal and the input material comprises at least one of whole logs and/or split logs.

15. The method of any one of the clauses herein, wherein the charred product comprises biochar and the input material comprises biomass.

16. The method of any one of the clauses herein, wherein the input material comprises wood and the charred product comprises charcoal, and wherein a ratio of the charcoal to the wood is at least 20%, 22%, 24%, 26%, 28%, 30%, or within a range of 20-30%.

17. The method of any one of the clauses herein, wherein the charred product comprises a volatile matter content of at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, or within a range of 1-25%.

18. The method of any one of the clauses herein, wherein the charred product comprises an average volatile matter content of 4-6%, wherein a first amount of individual particles of the charred product comprises a volatile matter content of no more than 2%, and wherein a second amount of individual particles of the charred product comprises a volatile matter content of at least 8%.

19. The method of any one of the clauses herein, wherein the charred product comprises a volatile matter content of no more than 5%, 4%, 3%, 2%%, or within a range of 2-5%.

20. The method of any one of the clauses herein, wherein the charred product comprises 3-8%, 4-6%, or 5-6% ash.

21. The method of any one of the clauses herein, wherein the charred product comprises no more than 8%, 7%, 6%, or 5% ash.

22. The method of any one of the clauses herein, wherein an ash of the charred product comprises no more than 0.5%, 0.25%, 0.1%, or 0.05% sulfur.

23. The method of any one of the clauses herein, wherein the ash of the charred product comprises at least 60%, 65%, 70%, 75%, or 78% calcium oxide.

24. The method of any one of the clauses herein, wherein at least 12%, 14%, 16%, 18%, 20%, or within a range of 12-20% of the charred product has a size of at least ¾″.

25. The method of any one of the clauses herein, wherein at least 6%, 8%, 10%, or within a range of 6-10% of the charred product comprises fines having a size of less than ¾″.

26. The method of any one of the clauses herein, wherein the charred product comprises a charcoal to fines ratio of at least 2.0, 2.5, 3.0, 3.5, 4.5, 5.0, 5.5, 6.0, 6.5, 7.0, 8.0, 9.0, 10.0, or within a range of 2.0-10.0.

27. The method of any one of the clauses herein, wherein receiving the input material comprises receiving an at least partially enclosed container including the input material therein.

28. The method of clause 25, further comprising cooling the partially enclosed container and/or charred product to 120° F. or less in the oven.

29. The method of any one of the clauses herein, further comprising (i) fluidically isolating the charred product from oxygen, and (ii) cooling the partially enclosed container and/or charred product to 120° F. or less while the charred product is fluidically isolated.

30. A system for producing char, the system comprising:
an oven configured to receive a carbonaceous input material and be heated to a predetermined temperature of at least 900° F. for a predetermined time of no more than 48 hours to produce a charred product.

31. The system of any one of the clauses herein, wherein the input material comprises at least one of a carbonaceous feedstock, a non-metal feedstock, or a metal-containing feedstock.

32. The system of any one of the clauses herein, wherein the input material comprises a metal-containing feedstock including a raw mineral material or a recycled metal-containing material.

33. The system of any one of the clauses herein, wherein the input material comprises iron fines.

34. The m system of any one of the clauses herein, wherein the input material comprises an additive including calcium (e.g., calcium oxide or lime, calcium sulfate, etc.), sodium (e.g., sodium hydroxide), and/or clay.

35. The system of any one of the clauses herein, wherein at least some of the input material have a smallest cross-sectional dimension of at least 2 inches, 3 inches, 4 inches, 5 inches, or 6 inches.

36. The system of any one of the clauses herein, wherein the input material has an input moisture content of at least 10%, 12%, 14%, 16%, 18%, 20%, 22%, 24%, 26%, 28%, 30%, 40%, 50%, or within a range of 10-50%.

37. The system of any one of the clauses herein, wherein the wood comprises logs having an average cross-sectional diameter or dimension of at least 2″, 4″, 6″, 8″, 10″ 12″, 14″, 16″, 18″, 20″, 22″, 24″, or within a range of 2-24″.

38. The system of any one of the clauses herein, wherein the predetermined time is no more than 46 hours, 44 hours, 42 hours, 40 hours, 38 hours, 36 hours, 34 hours, 32 hours, 30 hours, 28 hours, 26 hours, 24 hours, 22 hours, 20 hours, 18 hours, 16 hours, 14 hours, or within a range of 14-46 hours.

39. The system of any one of the clauses herein, wherein the predetermined temperature is at least 950° F., 1000° F., 1050° F., 1100° F., 1150° F., 1200° F., 1250° F., 1300° F., 1400° F., 1500° F., 1750° F., 2000° F., 2250° F., 2500° F., 2800° F., or within a range of 950-2800° F.

40. The system of any one of the clauses herein, wherein the predetermined temperature is within a range of 1150-1300° F., 1200-1300° F., or 1200-1250° F.

41. The system of any one of the clauses herein, wherein the charred product comprises charcoal and the input material comprises wood.

42. The system of any one of the clauses herein, wherein the charred product comprises charcoal and the input material comprises at least one of oak, red oak, hickory, spruce,
43. The system of any one of the clauses herein, wherein the charred product comprises charcoal and the input material comprises at least one of whole logs and/or split logs.

44. The system of any one of the clauses herein, wherein the charred product comprises biochar and the input material comprises biomass.

45. The system of any one of the clauses herein, wherein the input material comprises wood and the charred product comprises charcoal, and wherein a ratio of the charcoal to the wood is at least 20%, 22%, 24%, 26%, 28%, 30%, or within a range of 20-30%.

46. The system of any one of the clauses herein, wherein the charred product comprises a volatile matter content of at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, or within a range of 1-25%.

47. The system of any one of the clauses herein, wherein the charred product comprises an average volatile matter content of 4-6%, wherein a first amount of individual particles of the charred product comprises a volatile matter content of no more than 2%, and wherein a second amount of individual particles of the charred product comprises a volatile matter content of at least 8%.

48. The system of any one of the clauses herein, wherein the charred product comprises a volatile matter content of no more than 5%, 4%, 3%, 2%%, or within a range of 2-5%.

49. The system of any one of the clauses herein, wherein the charred product comprises 3-8%, 4-6%, or 5-6% ash.

50. The system of any one of the clauses herein, wherein the charred product comprises no more than 8%, 7%, 6%, or 5% ash.

51. The system of any one of the clauses herein, wherein an ash of the charred product comprises no more than 0.5%, 0.25%, 0.1%, or 0.05% sulfur.

52. The system of any one of the clauses herein, wherein the ash of the charred product comprises at least 60%, 65%, 70%, 75%, or 78% calcium oxide.

53. The system of any one of the clauses herein, wherein at least 12%, 14%, 16%, 18%, 20%, or within a range of 12-20% of the charred product has a size of at least ¾″.

54. The system of any one of the clauses herein, wherein at least 6%, 8%, 10%, or within a range of 6-10% of the charred product comprises fines having a size of less than ¾″.

55. The system of any one of the clauses herein, wherein the charred product comprises a charcoal to fines ratio of at least 2.0, 2.5, 3.0, 3.5, 4.5, 5.0, 5.5, 6.0, 6.5, 7.0, 8.0, 9.0, 10.0, or within a range of 2.0-10.0.

56. A charred product, comprising
charcoal and/or biochar;
a volatile matter content within a range of 2-15%;
an ash content of 3-8%; and
a sulfur content of no more than 0.25%.

57. The charred product of any one of the clauses herein, wherein the charred product comprises charcoal or biochar.

58. The charred product of any one of the clauses herein, wherein the charred product comprises a volatile matter content of at least 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, or within a range of 1-25%.

59. The charred product of any one of the clauses herein, wherein the charred product comprises an average volatile matter content of 4-6%, wherein a first amount of individual particles of the charred product comprises a volatile matter content of no more than 2%, and wherein a second amount of individual particles of the charred product comprises a volatile matter content of at least 8%.

60. The charred product of any one of the clauses herein, wherein the charred product comprises a volatile matter content of no more than 5%, 4%, 3%, 2%%, or within a range of 2-5%.

61. The charred product of any one of the clauses herein, wherein the charred product comprises 3-8%, 4-6%, or 5-6% ash.

62. The charred product of any one of the clauses herein, wherein the charred product comprises no more than 8%, 7%, 6%, or 5% ash.

63. The charred product of any one of the clauses herein, wherein an ash of the charred product comprises no more than 0.5%, 0.25%, 0.1%, or 0.05% sulfur.

64. The charred product of any one of the clauses herein, wherein the ash of the charred product comprises at least 60%, 65%, 70%, 75%, or 78% calcium oxide.

65. The charred product of any one of the clauses herein, wherein at least 12%, 14%, 16%, 18%, 20%, or within a range of 12-20% of the charred product has a size of at least ¾″.

66. The charred product of any one of the clauses herein, wherein at least 6%, 8%, 10%, or within a range of 6-10% of the charred product comprises fines having a size of less than ¾″.

67. The charred product of any one of the clauses herein, wherein the charred product comprises a charcoal to fines ratio of at least 2.0, 2.5, 3.0, 3.5, 4.0, 4.5, 5.0, 5.5, 6.0, 6.5, 7.0, 8.0, 9.0, 10.0, or within a range of 2.0-10.0.

68. A coal-char mixture product, comprising:
a coal blend; and
a charred product made from an input material that is heated to a predetermined temperature of at least 900° F. for a predetermined time of no more than 48 hours.

69. The mixture product of any one of the clauses herein, wherein a mass ratio of the charred product is at least 1%, 2%, 3%, 4%, 5%, 10%, 15%, or within a range of 1-15%.

70. The mixture product of any one of the clauses herein, wherein a mass ratio of the charred product is at least 15%, 20%, 25%, 30%, or within a range of 15-30%.

71. The mixture product of any one of the clauses herein, wherein the mixture product comprises a volatile matter content of at least 0.1%, 0.5%, 1%, 3%, 5%, or within a range of 0.1-5%.

72. The mixture product of any one of the clauses herein, wherein the mixture product comprises an ash content no more than 9%, 8%, 7%, 6%, 5%, 1%, 0.5%, 0.3%, 0.2%, 0.1%, or within a range of 0.1-9%.

73. The mixture product of any one of the clauses herein, wherein the mixture product comprises a sulfur content of no more than 1%, 0.9%, 0.8%, 0.7%, 0.5%, 0.25%, 0.1%, 0.05%, or within a range of 0.05-1%.

74. The mixture product of any one of the clauses herein, wherein ash of the charred product comprises at least 60%, 65%, 70%, 75%, 78%, or within a range of 60-78% calcium oxide.

75. The mixture product of any one of the clauses herein, wherein the charred product comprises grains having an average cross-sectional dimension of at least 2 mm, 3 mm, 4 mm, or within a range of 2-4 mm.

76. The mixture product of any one of the clauses herein, wherein the input material heated in a heat recovery oven.

77. The mixture product of any one of the clauses herein, further comprising a second coal blend, wherein the coal blend and the second coal blend have different volatile matter mass fractions.

78. A coke-char mixture product, the mixture product comprising:
a coked product made from a coal blend that is heated in an oven; and
a double-charred product made from a charred product that is heated with the coal blend in the oven, wherein the charred product is made from an input material heated to a predetermined temperature of at least 900° F. for a predetermined time of no more than 48 hours.

79. The mixture product of any one of the clauses herein, wherein the coked product has a Coke Strength After Reaction (CSR) of no more than 2%, 1%, 0.5%, 0.1%, or within a range of 0.1-2%.

80. The mixture product of any one of the clauses herein, wherein the coked product has a Coke Reactivity Index (CRI) of at least 30%, 40%, 50%, 60%, or within a range of 30-60%.

81. The mixture product of any one of the clauses herein, wherein the coked product comprises foundry coke.

82. The mixture product of any one of the clauses herein, wherein the charred product comprises charcoal or biochar.

83. The mixture product of any one of the clauses herein, wherein the coked product comprises an average volatile matter content of 0.1-1%, wherein a first amount of individual particles of the mixture product comprises a volatile matter content of no more than 0.1%, and wherein a second amount of individual particles of the mixture product comprises a volatile matter content of at least 0.5%.

84. The mixture product of any one of the clauses herein, wherein at least 12%, 14%, 16%, 18%, 20%, or within a range of 12-20% of the charred product has a size of at least ⅛ inch.

85. The mixture product of any one of the clauses herein, wherein at least 80%, 85%, 90%, 95%, 99%, or within a range of 80-99% of the charred product has a size of no more than ⅛ inch.

86. A system for producing a coal-char mixture product, the system comprising:
an oven configured to receive a carbonaceous input material and be heated to a predetermined temperature of at least 900° F. for a predetermined time of no more than 48 hours to produce a charred product; and
a mixing assembly configured to receive and mix the charred product from the oven and a coal blend to form the coal-char mixture product.

87. The system of any one of the clauses herein, wherein the input material comprises at least one of a carbonaceous feedstock, a non-metal feedstock, or a metal-containing feedstock.

88. The system of any one of the clauses herein, wherein the input material comprises wood logs having an average cross-sectional diameter or dimension of at least 2″, 4″, 6″, 8″, 10″ 12″, 14″, 16″, 18″, 20″, 22″, 24″, or within a range of 2-24″.

89. The system of any one of the clauses herein, wherein at least some of the input material have a smallest cross-sectional dimension of at least 2 inches, 3 inches, 4 inches, 5 inches, 6 inches, or within a range of 2-6 inches.

90. The system of any one of the clauses herein, wherein the input material has an input moisture content of at least 10%, 12%, 14%, 16%, 18%, 20%, 22%, 24%, 26%, 28%, 30%, 40%, 50%, or within a range of 10-50%.

91. The system of any one of the clauses herein, wherein the charred product comprises charcoal and the input material comprises wood.

92. The system of any one of the clauses herein, wherein the charred product comprises biochar and the input material comprises biomass.

93. The system of any one of the clauses herein, wherein the oven is further configured to receive the coal-char mixture product and be heated to a second predetermined temperature of at least 900° F. for a second predetermined time of no more than 48 hours to produce a coke-char mixture product.

94. The system of any one of the clauses herein, further comprising a grinder or mill configured to reduce a size of the input material before the oven receives the input material.

95. A method for producing a coal-char mixture product, the method comprising:
receiving an input material in an oven;
heating the oven containing the input material to a predetermined temperature of at least 900° F. for a predetermined time of no more than 48 hours to produce a charred product; and
mixing the charred product from the oven and a coal blend to form the coal-char mixture product.

96. The method of any one of the clauses herein, wherein the predetermined temperature is within a range of 1150-1300° F., 1200-1300° F., or 1200-1250° F.

97. The method of any one of the clauses herein, wherein the input material comprises an additive including calcium, sodium, and/or clay.

98. The method of any one of the clauses herein, wherein the predetermined time is no more than 46 hours, 44 hours, 42 hours, 40 hours, 38 hours, 36 hours, 34 hours, 32 hours, 30 hours, 28 hours, 26 hours, 24 hours, 22 hours, 20 hours, 18 hours, 16 hours, 14 hours, or within a range of 14-46 hours.

99. The method of any one of the clauses herein, wherein receiving the input material in the oven comprises receiving an at least partially enclosed container including the input material therein.

100. The method of any one of the clauses herein, further comprising cooling the at least partially enclosed container and/or the charred product to 120° F. or less in the oven.

101. The method of any one of the clauses herein, further comprising:
fluidically isolating the charred product from oxygen; and
cooling the at least partially enclosed container and/or the charred product to 120° F. or less in the oven while the charred product is fluidically isolated.

102. The method of any one of the clauses herein, further comprising:
receiving the coal-char mixture product in the oven; and
heating the oven containing the coal-char mixture product to a second predetermined temperature of at least 900° F. for a second predetermined time of no more than 48 hours to produce a coke-char mixture product.

I/We claim:

1. A coal-char mixture product configured to be processed in an oven, comprising:
a coal blend; and
a charred product, wherein a size of the individual grains of the charred product is no larger than a size of individual coals of the coal blend.

2. The mixture product of claim 1, wherein a mass ratio of the charred product is at least 10%.

3. The mixture product of claim 1, wherein the charred product comprises a volatile matter content of at least 1%.

4. The mixture product of claim 1, wherein the mixture product comprises an ash content within a range of 0.1-9%.

5. The mixture product of claim 1, wherein the mixture product comprises a sulfur content within a range of 0.05-1%.

6. The mixture product of claim 1, wherein ash of the charred product comprises at least 60% calcium oxide.

7. The mixture product of claim 1, wherein the charred product comprises individual grains having an average cross-sectional dimension of no more than 3 mm.

8. The mixture product of claim 1, wherein the charred product is made from an input material that is heated to a predetermined temperature of at least 900° F. for a predetermined time of no more than 48 hours.

9. The mixture product of claim 8, wherein the input material is heated in a heat recovery oven.

10. The mixture product of claim 1, wherein the coal blend is a first coal blend, the mixture product further comprising a second coal blend, wherein the first coal blend has a first volatile mass fraction and the second coal blend has a second volatile matter mass fraction different than the first volatile mass fraction.

11. A coke-char mixture product, the mixture product comprising:
a coked product made from a coal blend that is heated in an oven; and
a double-charred product made from a charred product that is heated with the coal blend in the oven, wherein the charred product is made from an input material heated to a predetermined temperature of at least 900° F. for a predetermined time of no more than 48 hours.

12. The mixture product of claim 11, wherein the coked product comprises a volatile matter content of at least 0.1%.

13. The mixture product of claim 11, wherein the coked product has a Coke Strength After Reaction (CSR) of no more than 12%.

14. The mixture product of claim 11, wherein the coked product has a Coke Reactivity Index (CRI) of at least 30%.

15. The mixture product of claim 11, wherein the coked product comprises foundry coke.

16. The mixture product of claim 11, wherein the charred product comprises charcoal or biochar.

17. The mixture product of claim 11, wherein the mixture product comprises an average volatile matter content of 0.1-1%, wherein a first amount of individual particles of the mixture product comprises a volatile matter content of no more than 0.1%, and wherein a second amount of individual particles of the mixture product comprises a volatile matter content of at least 0.5%.

18. The mixture product of claim 11, wherein at least 10% of the charred product has a size of at least ⅛ inch.

19. The mixture product of claim 11, wherein at least 90% of the charred product has a size of no more than ⅛ inch.

20. A system for producing a coal-char mixture product, the system comprising:
an oven configured to receive a carbonaceous input material and be heated to a predetermined temperature of at least 900° F. for a predetermined time of no more than 48 hours to produce a charred product; and
a mixing assembly configured to receive and mix the charred product from the oven and a coal blend to form the coal-char mixture product.

21. The system of claim 20, wherein the input material comprises wood logs having an average cross-sectional diameter or dimension of at least 2″.

22. The system of claim 20, wherein at least some of the input material have a smallest cross-sectional dimension of at least 2 inches.

23. The system of claim 20, wherein the input material has an input moisture content within a range of 10-50%.

24. A method for producing a coal-char mixture product, the method comprising:
receiving an input material in an oven;
heating the oven containing the input material to a predetermined temperature of at least 900° F. for a predetermined time of no more than 48 hours to produce a charred product; and
mixing the charred product from the oven and a coal blend to form the coal-char mixture product.

25. The method of claim 24, wherein the predetermined temperature is within a range of 1150-1300° F.

26. The method of claim 24, wherein the input material comprises an additive including calcium, sodium, and/or clay.
